(19) United States
(12) Patent Application Publication
(10) Pub. No.: US 2023/0418895 A1
(43) Pub. Date: Dec. 28, 2023

(54) SOLVER APPARATUS AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/466,878

(22) Filed: Sep. 14, 2023

Related U.S. Application Data
(63) Continuation of application No. PCT/JP2022/012072, filed on Mar. 16, 2022.

(30) Foreign Application Priority Data
Mar. 17, 2021 (JP) 2021-043184

(51) Int. Cl. G06F 17/12

(52) U.S. Cl. CPC G06F 17/12

(57) ABSTRACT

A good solution is efficiently calculated. The solver apparatus calculates a solution to a problem minimizing an objective function as a non-convex quadratic function under a condition satisfying J simultaneous-linear-equations and satisfying K simultaneous-linear-inequalities. The solver apparatus includes an acquisition unit, an update unit, and an output unit. The update unit repeats, in predetermined order, first-processing of acquiring candidate values of solutions of the I-decision-variables minimizing a first function including the I-decision-variables generated using an augmented-Lagrange function, second-processing of acquiring candidate values of solutions of the K dependent-variables minimizing a second function including K dependent-variables generated using the augmented-Lagrange function, and the coefficient-processing of updating a coefficient included in the augmented-Lagrange function. The augmented-Lagrange function includes an objective function term including an objective function, J first Lagrange terms corresponding to the J simultaneous-linear-equations, K second Lagrange terms corresponding to the K simultaneous-linear-inequalities, and a penalty term.

### CROSS-REFERENCE TO RELATED APPLICATIONS

This application is a continuation of International Application No. PCT/JP2022/012072 filed on Mar. 16, 2022 based on JP Application 2021-043184 filed on Mar. 17, 2021, the entire contents of which are incorporated herein by reference.

### FIELD

The embodiments herein relate to a solver apparatus and a computer program product.

### BACKGROUND

One of optimization problems is known as a linear constraint/0-1 integer non-convex quadratic programming problem. The linear constraint/0-1 integer non-convex quadratic programming problem is a problem of calculating a solution that minimizes a non-convex quadratic function including decision variables that are each zero or one respectively under constraint conditions of a plurality of simultaneous linear equations and a plurality of simultaneous linear inequalities. The linear constraint/0-1 integer non-convex quadratic programming problem is applied to scheduling optimization and the like.

As a method for solving the linear constraint/0-1 integer non-convex quadratic programming problem, for example, a branch and bound method or an approximate solution method is known. The branch and bound method performs case division on each of the decision variables, and calculates an upper bound and a lower bound of an objective function value. Furthermore, the branch and bound method calculates a global optimal solution while narrowing down a range that can take the global optimal solution.

According to the approximate solution method, for example, each of an equality constraint and an inequality constraint is expressed by a barrier function that is proportional to a square of an amount that violates the constraints. Furthermore, the approximate solution method performs conversion into an unconstrained/0-1 integer non-convex quadratic programming problem by using only the constraint that is estimated to be valid, and this problem is solved by an Ising machine.

However, the branch and bound method performs case division on each of the decision variables, and therefore has exponentially increased the calculation amount with respect to the number of decision variables. Furthermore, when an inclination of the objective function around the constraint is great, the approximate solution method has to make a penalty parameter that is a proportionality coefficient of the barrier function larger than the inclination of the objective function.

In such a case, according to the approximate solution method, the magnitude of the coefficient of an input matrix to the Ising machine is larger in a coefficient derived from the penalty parameter than in the coefficient derived from the objective function. [symbol] , Hence, the approximate solution method requires much of calculation performance of the Ising machine to calculate a feasible solution, resulting in poor efficiency. Furthermore, the approximate solution method may reach a solution having a bad objective function value, and therefore has needed to perform hyperparameter tuning on the penalty parameter to reach a solution having a good objective function value, and processing has become complicated.

### BRIEF DESCRIPTION OF THE DRAWINGS

FIG. 1 is a diagram illustrating a functional configuration of a solver apparatus according to a first embodiment.

FIG. 2 is a flowchart illustrating a flow of processing of the solver apparatus according to the first embodiment.

FIG. 3 is a diagram illustrating a functional configuration of a solver apparatus according to a second embodiment.

FIG. 4 is a flowchart illustrating a flow of processing of the solver apparatus according to the second embodiment.

FIG. 5 is a diagram illustrating a hardware configuration of the solver apparatus.

### DETAILED DESCRIPTION

The problem to be solved by the embodiments herein is to provide a solver apparatus and a computer program product that can efficiently calculate a good solution.

A solver apparatus according to an embodiment calculates a solution to a problem minimizing an objective function that is a non-convex quadratic function including I (I is an integer equal to or more than two) decision variables that are each zero or one under a condition satisfying J (J is an integer equal to or more than zero) simultaneous linear equations that each include at least one of the I decision variables as a variable and satisfying K (K is an integer equal to or more than one) simultaneous linear inequalities that each include at least one of the I decision variables as a variable. The solver apparatus includes an acquisition unit, an update unit, and an output unit. The acquisition unit acquires the objective function, the J simultaneous linear equations, and the K simultaneous linear inequalities. The update unit repeats first processing of acquiring candidate values of solutions of the I decision variables that minimize a first function including the I decision variables generated based on an augmented Lagrange function, second processing of acquiring candidate values of solutions of the K dependent variables that minimize a second function including K dependent variables generated based on the augmented Lagrange function, and coefficient processing of updating a coefficient included in the augmented Lagrange function in predetermined order. The output unit outputs the candidate values of the solutions of the I decision variables as the solution to the problem when a preset end condition is reached by repeating the first processing, the second processing, and the coefficient processing. The augmented Lagrange function includes an objective function term including the objective function, J first Lagrange terms corresponding to the J simultaneous linear equations, K second Lagrange terms corresponding to the K simultaneous linear inequalities, and a penalty term.

Hereinafter, a solver apparatus 10 according to embodiments will be described with reference to the drawings.

### First Embodiment

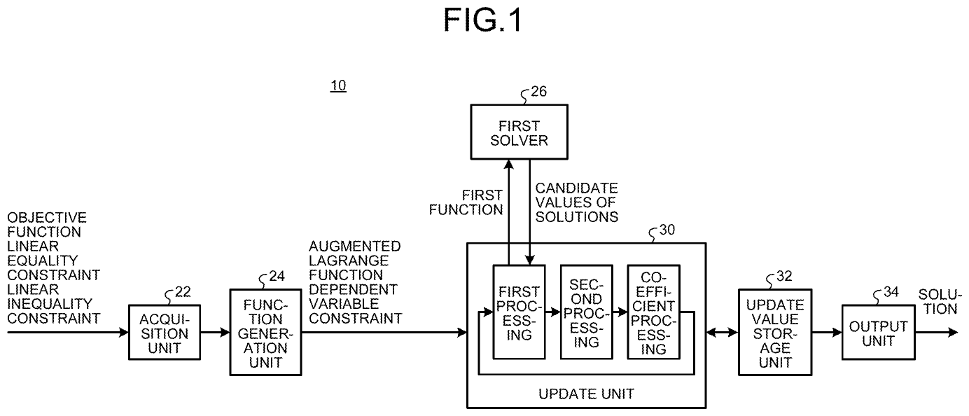

FIG. 1 is a diagram illustrating a functional configuration of the solver apparatus 10 according to the first embodiment.

The solver apparatus 10 according to the first embodiment calculates a solution to a 0-1 integer non-convex quadratic programming problem including a linear constraint condition. The solver apparatus 10 is implemented when a processor, a computer, a server, or the like executes a program.

More specifically, the solver apparatus 10 calculates a solution to a problem that minimizes an objective function that is an integer non-convex quadratic function under a condition that satisfies a linear constraint. The objective function includes I (I is an integer equal to or more than two) decision variables that are each zero or one.

The linear constraint includes a linear equality constraint and a linear inequality constraint. The linear equality constraint is expressed by J (J is an integer equal to or more than zero) simultaneous linear equations. Each of the J simultaneous linear equations includes at least one of the I decision variables as a variable. Note that the linear constraint may not include the linear equality constraint. In this case, the solver apparatus 10 handles J simultaneous linear equations assuming J=0.

The linear inequality constraint is expressed by K (K is an integer equal to or more than one) simultaneous linear inequalities. Each of the K simultaneous linear inequalities includes at least one of the I decision variables as a variable.

The solver apparatus 10 according to the first embodiment includes an acquisition unit 22, a function generation unit 24, a first solver 26, an update unit 30, an update value storage unit 32, and an output unit 34.

The acquisition unit 22 acquires the objective function, the linear equality constraint, and the linear inequality constraint input when a user operates operation means. The acquisition unit 22 may receive these pieces of information from another apparatus via a network or the like.

The function generation unit 24 generates an augmented Lagrange function and a dependent variable constraint based on the information acquired by the acquisition unit 22.

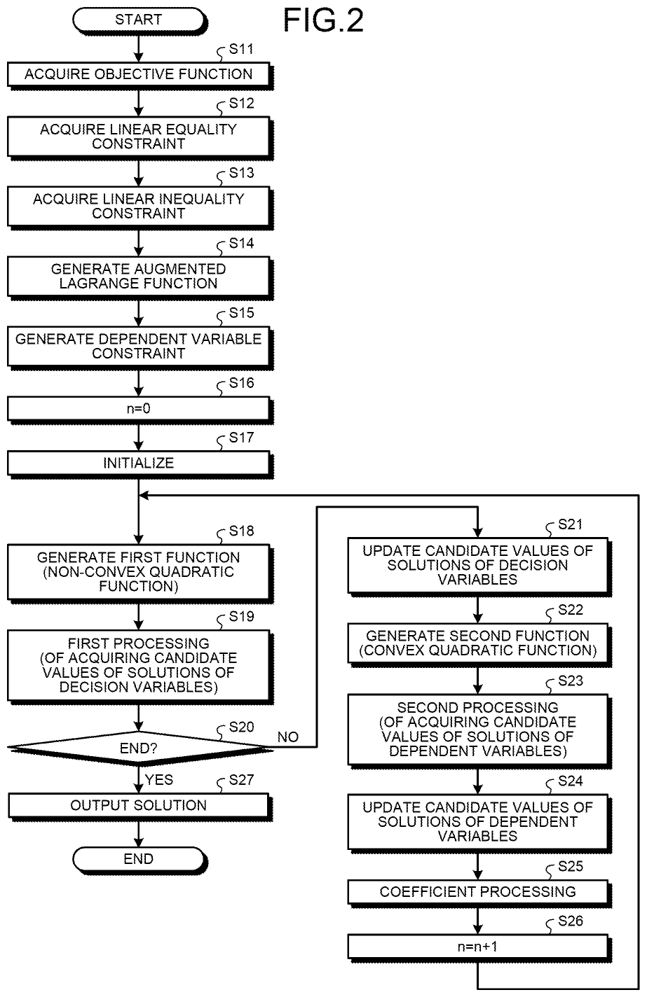

The augmented Lagrange function is a function generated to efficiently calculate a solution to a problem. The augmented Lagrange function includes the I decision variables and K dependent variables. Each of the K dependent variables is set to calculate the solution to the problem. Each of the K dependent variables takes a value of a real number. The dependent variable constraint is expressed by K inequalities that constrain the value of each of the K dependent variables. Note that further details of the augmented Lagrange function and the dependent variable constraint will be described later with reference to FIG. 2.

The first solver 26 calculates a solution to a 0-1 integer non-convex quadratic programming problem that does not include a constraint condition. That is, the first solver 26 calculates the solution to the problem that minimizes the 0-1 integer non-convex quadratic function. The first solver 26 may be a solver that calculates a solution to the Ising problem. The first solver 26 is implemented when, for example, a processor or a computer implemented as the solver apparatus 10 executes a solving program for the 0-1 integer non-convex quadratic programming problem. Furthermore, the first solver 26 may be provided by a server or the like. In this case, the first solver 26 may be implemented outside the solver apparatus 10. In the case where the first solver 26 is implemented outside the solver apparatus 10, the solver apparatus 10 gives an objective function to the first solver 26 via a network, and acquires candidate values of solutions from the first solver 26 via the network.

The update unit 30 repeats first processing, second processing, and coefficient processing until a preset end condition is reached. The update unit 30 repeats the first processing, the second processing, and the coefficient processing in order.

The first processing is processing of acquiring candidate values of solutions of the I decision variables that minimize a first function. The update unit 30 updates the candidate values of the solutions of the I decision variables every time the first processing is executed.

The first function is a function that includes the I decision variables generated based on the augmented Lagrange function. The first function is a function obtained by substituting candidate values of solutions of K dependent variables into the augmented Lagrange function. The candidate values of the solutions of the K dependent variables are values based on latest second processing. Furthermore, in a case where the initial first processing is executed before the initial second processing is executed, the candidate values of the solutions of the K dependent variables are preset initial values.

The first function is an integer non-convex quadratic function. Therefore, in the first processing, the update unit 30 gives a problem that minimizes a first function to the first solver 26, and acquires candidate values of solutions of the I decision variables as the solution to the problem from the first solver 26. Note that further details of the first function will be described later with reference to FIG. 2.

The second processing is processing of acquiring the candidate values of the solutions of the K dependent variables that minimize a second function under a condition that satisfies the dependent variable constraint expressed by the K inequalities. The update unit 30 updates the candidate values of the solutions of the K dependent variables every time the second processing is executed.

The second function is a function that includes the K dependent variables generated based on the augmented Lagrange function. The second function is a function obtained by substituting the candidate values of the solutions of the I decision variables into the augmented Lagrange function. The candidate values of the solutions of the I decision variables are values updated based on the latest first processing. Furthermore, in a case where the initial second processing is executed before the initial first processing is executed, the candidate values of the solutions of the K decision variables are preset initial values.

The K inequalities correspond to the K dependent variables. Each of the K inequalities expresses a minimum value that a corresponding dependent variable can take.

In the first embodiment, the K dependent variables in the second function are independent from each other. The term of each dependent variable of the second function is a convex quadratic function. Therefore, in the second processing, the update unit 30 calculates the candidate values of the solutions of the K dependent variables that minimize the second function under a condition that satisfies the dependent variable constraint expressed by the K inequalities, by computation processing without using the solver or the like. Note that further details of the second function will be described later with reference to FIG. 2.

The coefficient processing is processing of updating each of a plurality of coefficients included in the augmented Lagrange function. The update unit 30 updates each of the plurality of coefficients included in the augmented Lagrange function based on the candidate values of the solutions of the I decision variables updated based on the latest first processing, and the candidate values of the solutions of the K dependent variables updated based on the latest second processing. Note that each of the plurality of coefficients included in the augmented Lagrange function takes a preset initial value before the initial first processing and the initial second processing are executed. Note that further details of the computation processing of updating the coefficients will be described later with reference to FIG. 2.

The update value storage unit 32 stores the candidate values of the solutions of the I decision variables, the candidate values of the solutions of the K dependent variables, and the plurality of coefficients included in the augmented Lagrange function. The update unit 30 updates the corresponding values stored in the update value storage unit 32 every time the first processing, the second processing, and the coefficient processing are executed.

When the update unit 30 repeats the first processing, the second processing, and the coefficient processing, and thereby the preset end condition is reached, the output unit 34 outputs the candidate values of the solutions of the I decision variables as the solution to the 0-1 integer non-convex quadratic programming problem that is a solution target and includes the linear constraint condition.

In a case where, for example, the candidate values of the solutions of the I decision variables satisfy the linear equality constraint and the linear inequality constraint, and the value of the objective function into which the candidate values of the solutions of the I decision variables have been substituted is equal to or less than a predetermined threshold, the output unit 34 may determine that the end condition has been reached. In addition to this or instead of this, in a case where the candidate values of the solutions of the I decision variables satisfy the linear equality constraint and the linear inequality constraint, and the number of times of repetition performed by the update unit 30 exceeds a preset number of times, the output unit 34 may determine that the end condition has been reached. Note that, in a case where the candidate values of the solutions of the I decision variables do not satisfy the linear equality constraint and the linear inequality constraint even when the number of times of repetition performed by the update unit 30 exceeds the preset number of times, the output unit 34 may output information indicating that the solution cannot be calculated.

The output unit 34 may present the solution to the user by displaying the solution on display means. Furthermore, the output unit 34 may transmit the solution to an external apparatus via the network.

FIG. 2 is a flowchart illustrating a flow of processing of the solver apparatus 10 according to the first embodiment. The solver apparatus 10 executes processing according to the flow illustrated in FIG. 2.

First, in S11, the acquisition unit 22 acquires the objective function that is the integer non-convex quadratic function including the I decision variables that are each zero or one.

The I decision variables are expressed as in equation (1).

xᵢ (1)

Each of the I decision variables is zero or one, and is constrained as in equation (2).

xᵢϵ{0,1} (2)

The objective function is expressed as in equation (3).

$${\sum }_{i , {i}^{′}} {x}_{i} \cdot {P}_{i , {i}^{′}} \cdot {x}_{{i}^{′}} + {\sum }_{i} {Q}_{i} \cdot {x}_{i} \qquad ( 3 )$$

i is an integer equal to or more than one and

equal to or less than I, and represents an index to be allocated to each of the I decision variables. i′ is an integer equal to or larger than one and equal to or less than I, and represents an index to be allocated to each of the I decision variables unlike i. That is, of the I decision variables, x₁ represents the first decision variable, x₂ represents the second decision variable, x 1 represents an I-th decision variable, xᵢ represents an i-th decision variable, and x_{i′} represents an i′-th decision variable.

P_{i, i′} represents a coefficient to be multiplied on a multiplication value of the i-th decision variable and the i′-th decision variable in a second order term of the objective function. P_{i, i′} represents a real number. Qᵢ represents a coefficient to be multiplied on the i-th decision variable in a first-order term of the objective function. Qᵢ represents a real number.

Subsequently, in S12, the acquisition unit 22 acquires the linear equality constraint. More specifically, the linear equality constraint is expressed by the J simultaneous linear equations in equation (4).

$${\sum }_{i} {A}_{j , i} \cdot {x}_{i} = {B}_{j} \qquad ( 4 )$$

j is an integer equal to or more than one and equal to or less than J, and represents an index to be allocated to each of the J simultaneous linear equations. A_{j, i} represents a coefficient to be multiplied on the i-th decision variable in a j-th simultaneous linear equation. A_{j, i} represents a real number. Bⱼ represents a constant term in the j-th simultaneous linear equation. Bⱼ represents a real number.

Note that the acquisition unit 22 may not acquire the linear equality constraint. In a case where the linear equality constraint is not acquired, the solver apparatus does not execute computation on j assuming J=0.

Subsequently, in S13, the acquisition unit 22 acquires the linear inequality constraint. More specifically, the linear inequality constraint is expressed by K simultaneous linear inequalities in equation (5).

$${\sum }_{i} {C}_{k , i} \cdot {x}_{i} \leq {D}_{k} \qquad ( 5 )$$

Where, k represents an integer equal to or more than one and equal to or less than K, and represents an index to be allocated to each of the K simultaneous linear inequalities. C_{k, i} represents a coefficient to be multiplied on the i-th decision variable in a k-th simultaneous linear inequality. C_{k, i} represents a real number. Dₖ represents a constant term in the k-th simultaneous linear inequality. Dₖ represents a real number.

Subsequently, in S14, the function generation unit 24 generates the augmented Lagrange function based on the objective function, the J simultaneous linear equations, and the K simultaneous linear inequalities. The augmented Lagrange function is expressed by equation (6).

$$L ( x , z , λ , {λ}^{′} , μ ) = {\sum }_{j , {i}^{′}} {x}_{i} \cdot {P}_{i , {i}^{′}} \cdot {x}_{{i}^{′}} + {\sum }_{i} {Q}_{i} \cdot {x}_{i} - {\sum }_{j} {λ}_{j} \cdot ( {\sum }_{i} {A}_{j , i} \cdot {x}_{i} - {B}_{j} ) - {\sum }_{k} {λ}_{k}^{′} \cdot ( {\sum }_{i} {C}_{k , i} \cdot {x}_{i} - {z}_{k} ) + \frac{μ}{2} ( {\sum }_{j} {( {\sum }_{i} {A}_{j , i} \cdot {x}_{i} - {B}_{j} )}^{2} + {\sum }_{k} {( {\sum }_{i} {C}_{k , i} \cdot {x}_{i} - {z}_{k} )}^{2} ) \qquad ( 6 )$$

The augmented Lagrange function includes an objective function term, J first Lagrange terms, K second Lagrange terms, and a penalty term.

The objective function term includes the objective function. The objective function term is expressed by equation (7).

$${\sum }_{i , {i}^{′}} {x}_{i} \cdot {P}_{i , {i}^{′}} \cdot {x}_{{i}^{′}} + {\sum }_{i} {Q}_{i} \cdot {x}_{i} \qquad ( 7 )$$

The J first Lagrange terms correspond to the J simultaneous linear equations. An equation obtained by summing the J first Lagrange terms is expressed by equation (8).

$$- {\sum }_{j} {λ}_{j} \cdot ( {\sum }_{i} {A}_{j , i} \cdot {x}_{i} - {B}_{j} ) \qquad ( 8 )$$

The function generation unit 24 sets J first Lagrange coefficients. λⱼ represents a j-th first Lagrange coefficient of the J first Lagrange coefficients. The j-th first Lagrange coefficient is included in a j-th first Lagrange term of the J first Lagrange terms. Each of the J first Lagrange coefficients is a real number.

Each of the J first Lagrange terms is a function obtained by multiplying by a corresponding first Lagrange coefficient of the J first Lagrange coefficients a function expressing an error between a corresponding simultaneous linear equation of the J simultaneous linear equations and the candidate values of the solutions of the I decision variables. That is, each of the J first Lagrange terms is a function that is 0 when the candidate values of the solutions of the I decision variables satisfy the corresponding linear equality constraint, and is shifted in a minus direction or a plus direction when the candidate values do not satisfy the corresponding linear equality constraint.

Note that −1 is multiplied at a head in equation (8). However, −1 may not be multiplied on equation (8).

The K second Lagrange terms correspond to the K simultaneous linear inequalities. An equation obtained by summing the K second Lagrange terms is expressed by equation (9).

$$- {\sum }_{k} {λ}_{k}^{′} \cdot ( {\sum }_{i} {C}_{k , i} \cdot {x}_{i} - {z}_{k} ) \qquad ( 9 )$$

The function generation unit 24 sets K second Lagrange coefficients. λ′_{K} represents a k-th second Lagrange coefficient of the K second Lagrange coefficients. The k-th second Lagrange coefficient is included in a k-th second Lagrange term of the K second Lagrange terms. Each of the K second Lagrange coefficients is a real number.

The function generation unit 24 sets the K dependent variables. zₖ represents a k-th dependent variable of the K dependent variables. The dependent variable takes a value of a real number.

Furthermore, the function generation unit 24 sets K alternative equations. The k-th dependent variable is included in a k-th alternative equation of the K alternative equations. The K alternative equations correspond to the K simultaneous linear inequalities. Each of the K alternative equations is an equation obtained by replacing an inequality sign of a corresponding simultaneous linear inequality of the K simultaneous linear inequalities with an equal sign, and replacing a constant term with a corresponding dependent variable of the K dependent variables. In a case of an example of equation (9), the k-th alternative equation is an equation obtained by replacing an inequality sign of equation (5) with an equal sign and replacing Dₖ with zₖ.

Each of the K second Lagrange terms is a function obtained by multiplying by a corresponding second Lagrange coefficient of the K second Lagrange coefficients a function expressing an error between a corresponding alternative equation of the K alternative equations and the candidate values of the solutions of the I decision variables. That is, each of the K second Lagrange terms is a function that is 0 when the candidate values of the solutions of the I decision variables satisfy the corresponding alternative equation, and is shifted in the minus direction or the plus direction when the candidate values do not satisfy the corresponding alternative equation.

Note that −1 is multiplied at a head in equation (9). However, −1 may not be multiplied on equation (9).

The penalty term is expressed by equation (10).

$$\frac{μ}{2} ( {\sum }_{j} {( {\sum }_{i} {A}_{j , i} \cdot {x}_{i} - {β}_{j} )}^{2} + {\sum }_{k} {( {\sum }_{i} {C}_{k , i} \cdot {x}_{i} - {z}_{k} )}^{2} ) \qquad ( 10 )$$

Where, μ represents a penalty coefficient. The penalty coefficient is a real number larger than 0. The penalty term is a function obtained by multiplying the sum of the J first distance functions and the K second distance functions by the penalty coefficient.

The J first distance functions correspond to the J simultaneous linear equations. Each of the J first distance functions is a function expressing a distance (first distance) between a corresponding simultaneous linear equation of the J simultaneous linear equations, and the candidate values of the solutions of the I decision variables. In a case of an example of equation (10), each of the J first distance functions is a function obtained by squaring an error between the corresponding simultaneous linear equation and the candidate values of the solutions of the I decision variables.

The K second distance functions correspond to the K alternative equations. Each of the K second distance functions is a function expressing a distance (second distance) between a corresponding alternative equation of the K alternative equations and the candidate values of the solutions of the I decision variables. In the case of the example of equation (10), each of the K second distance functions is a function obtained by squaring an error between the corresponding alternative equation and the candidate values of the solutions of the I decision variables. That is, the penalty term is a function that is shifted in the plus direction as the sum of the first distance and the second distance becomes plus.

Note that ½ is multiplied at a head in equation (10). However, equation (10) may be multiplied by a value other than ½ as long as the value is a real number larger than 0.

Subsequently, in S15, the function generation unit 24 generates the dependent variable constraint. The dependent variable constraint indicates a constraint condition of the K dependent variables.

The dependent variable constraint is expressed by the K inequalities. The K inequalities correspond to the K dependent variables. Each of the K inequalities expresses that the corresponding dependent variable is equal to or less than a constant. More specifically, the dependent variable constraint is expressed by equation (11).

zₖ≤Dₖ (11)

That is, each of the K inequalities expresses that a corresponding dependent variable of the K dependent variables is equal to or less than a constant term in a corresponding simultaneous linear inequality of the K simultaneous linear inequalities. In the case of an example of equation (11), each of the K inequalities is an inequality obtained by replacing a first-order term (ΣC_{k,i}·xᵢ) of the decision variable of equation (5) with zₖ.

Subsequently, in S16, the update unit 30 initializes n to 0. The update unit 30 repeats processing from S18 to S26. n represents the number of times of execution of the processing from S18 to S26. n takes an initial value of 0, and increases by 1.

Subsequently, in S17, prior to the initial first processing, the initial second processing, and initial coefficient processing, the update unit 30 substitutes a predetermined initial value into each of the candidate values of the solutions of the I decision variables, each of the candidate values of the solutions of the K dependent variables, each of the J first Lagrange coefficients, each of the K second Lagrange coefficients, and the penalty coefficient.

Note that each of the candidate values of the solutions of the I decision variables, each of the candidate values of the solutions of the K dependent variables, each of the J first Lagrange coefficients, each of the K second Lagrange coefficients, and the penalty coefficient are updated per loop processing from S18 to S26.

In this example, xᵢ[n] represents candidate values of the solutions of I decision variables after n-th loop processing. zₖ[n] represents the candidate values of the solutions of the K dependent variables after the n-th loop processing. λⱼ[n] represents a first Lagrange coefficient after the n-th loop processing. λ′ₖ[n] represents a second Lagrange coefficient after the n-th loop processing. μ[n] represents a penalty coefficient after the n-th loop processing. Note that xᵢ

represents an initial value of xᵢ[n]. zₖ

represents an initial value of zₖ[n]. λⱼ

represents an initial value of λⱼ[n]. λ′ₖ

represents an initial value of λ′ₖ[n]. μ

represents an initial value of μ[n].

For example, the update unit 30 initializes each of these values as in equation (12).

xᵢ[n]=0,zₖ[n]=min(0,Dₖ),λⱼ[n]=0,λ′ₖ[n]=0,μ[n]=μ₀ (12)

Where, μ₀ represents a predetermined real number larger than 0. min(A, B) in equation (12) represents a function for selecting A or B that takes a smaller value.

In S18, the update unit 30 generates the first function including the I decision variables based on the augmented Lagrange function. The first function generated by n+1-th loop processing is expressed by equation (13).

$$L ( x , z [ n ] , λ [ n ] , {λ}^{′} [ n ] , μ [ n ] ) = [ {\sum }_{i , {i}^{′}} {x}_{i} \cdot \{ {P}_{i , {i}^{′}} + \frac{μ}{2} \cdot {\sum }_{j} {A}_{j , i} \cdot {A}_{j , {i}^{′}} + \frac{μ}{2} \cdot {\sum }_{k} {C}_{k , i} \cdot {C}_{k , {i}^{′}} \} \cdot {x}_{{i}^{′}} + {\sum }_{i} \{ {Q}_{i} + {\sum }_{j} ( - {λ}_{j} - μ \cdot {B}_{j} ) \cdot {A}_{j , i} + {\sum }_{k} ( - {λ}_{k}^{′} - μ \cdot {z}_{k} ) \cdot {C}_{k . i} \} \cdot {x}_{i} ] \qquad ( 13 )$$

That is, the first function generated by the n+1-th loop processing is a function obtained by substituting into the augmented Lagrange function of equation (6) zₖ[n] that represents the candidate values of the solutions of the K dependent variables, λⱼ[n] that represents the J first Lagrange coefficients, λ′ₖ[n] that represents the K second Lagrange coefficients, and μ[n] that represents the penalty coefficient after latest loop processing (n-th loop processing). The first function is an integer non-convex quadratic function including the I decision variables. Note that, in the first loop processing, zₖ[n], λⱼ[n], λ′ₖ[n], and μ[n] after the latest loop processing take the initial values substituted in S17.

Subsequently, in S19, the update unit 30 executes the first processing. That is, the update unit 30 acquires the candidate values of the solutions of the I decision variables that minimize the first function. For example, the update unit 30 executes a function expressed by equation (14).

argₓ min L(x,z[n],λ[n],λ′[n],μ[n]) (14)

Where, min represents an operator that minimizes a following function. argₓ represents a function of acquiring a value of x. The update unit 30 gives the problem that minimizes the first function to the first solver 26 in response to execution of equation (14), and acquires candidate values of solutions of the I decision variables as the solution to the problem from the first solver 26.

Subsequently, in S20, the update unit 30 determines whether or not an end condition has been reached. In a case where the end condition has been reached, the update unit 30 advances the processing to S27. In a case where the end condition is not reached, the update unit 30 advances the processing to S21.

Subsequently, in S21, the update unit 30 updates each of the candidate values of the solutions of the I decision variables stored in the update value storage unit 32. Note that the first solver 26 may output a plurality of sets of candidate values of the solutions of the I decision variables. There is, for example, a case where the first solver 26 outputs predetermined sets of the candidate values of the solutions of the I decision variables whose values of the objective function are a minimum value to a predetermined-numbered value.

In such a case, the update unit 30 may calculate one set of the candidate values of the solutions of the I decision variables based on the plurality of sets of the candidate values of the solutions of the I decision variables. Furthermore, the update unit 30 may replace each (xᵢ[n+1]) of the candidate values of the solutions of the I decision variables in the n+1-th loop processing with a value calculated based on the plurality of sets of the candidate values of the solutions of the I decision variables. For example, the update unit 30 calculates an average value of a predetermined number of candidate values per decision variable. Furthermore, the update unit 30 may replace each of the candidate values of the solutions of the I decision variables with an average value of the candidate values of the solutions of a predetermined number of corresponding decision variables.

In S22, the update unit 30 generates the second function including the K dependent variables based on the augmented Lagrange function. The second function generated by the n+1-th loop processing is expressed by equation (15).

$$L ( x [ n + 1 ] , z , λ [ n ] , {λ}^{′} [ n ] , μ [ n ] ) = - {\sum }_{k} {λ}_{k}^{′} \cdot ( {\sum }_{i} {C}_{k , i} \cdot {x}_{i} - {z}_{k} ) + \frac{μ}{2} \cdot {\sum }_{k} {( {\sum }_{i} {C}_{k , i} \cdot {x}_{i} - {z}_{k} )}^{2} = \frac{μ}{2} \cdot {\sum }_{k} {( {\sum }_{i} {C}_{k , i} \cdot {x}_{i} - {z}_{k} - \frac{{λ}_{k}^{′}}{μ} )}^{2} \qquad ( 15 )$$

That is, the second function generated by the n+1-th loop processing is a function obtained by substituting into the augmented Lagrange function of equation (6) xᵢ[n+1] that represents the candidate values of the solutions of the I decision variables updated in latest step S21, λⱼ[n] that represents the J first Lagrange coefficients after latest loop processing (n-th loop process), λ′ₖ[n] that represents the K second Lagrange coefficients, and μ[n] that represents the penalty coefficient. The second function is the convex quadratic function including the K dependent variables. Note that, in the first loop processing, λⱼ[n], λ′ₖ[n], and μ[n] updated by the latest loop processing take the initial values substituted in S17.

Subsequently, in S23, the update unit 30 executes the second processing. That is, the update unit 30 acquires the candidate values of the solutions of the K dependent variables that minimize the second function under the condition that satisfies the dependent variable constraint expressed by the K inequalities. For example, the update unit 30 executes a function expressed by equation (16).

arg_{z} min[L(x[n+1],z,λ[n],λ′[n],μ[n])] subject to zₖ≤Dₖ (16).

Where, arg_{z} represents a function of acquiring the value of z.

Here, the second function is a convex quadratic function. Furthermore, each of zₖ that are the K dependent variables included in the second function is independent of other variables. Hence, each of the K dependent variables takes as a minimum value a solution whose function obtained by partially differentiating the second function becomes 0.

Hence, when a value of each of the K dependent variables at which a differential function becomes 0 satisfies a corresponding inequality, the update unit 30 acquires a value at which the differential function becomes 0 as a candidate value. Furthermore, in a case where the value of each of the K dependent variables at which the differential function becomes 0 does not satisfy the corresponding inequality, the update unit 30 acquires a minimum value that satisfies the corresponding inequality as the candidate value.

For example, the update unit 30 can acquire the minimum value of each of the K dependent variables included in the second function using a function expressed by equation (17).

$${z}_{k} = min \{ {\sum }_{i} {C}_{k , i} \cdot {x}_{i} - \frac{{λ}_{k}^{′}}{μ} , {D}_{k} \} \qquad ( 17 )$$

Note that min(A, B) represents a function of selecting A or B that is a smaller value.

Subsequently, in S24, the update unit 30 updates each of the candidate values of the solutions of the K dependent variables stored in the update value storage unit 32.

Subsequently, in S25, the update unit 30 executes the coefficient processing. That is, the update unit 30 updates the J first Lagrange coefficients, the K second Lagrange coefficients, and the penalty coefficient stored in the update value storage unit 32.

More specifically, the update unit 30 subtracts a value corresponding to an error between the corresponding simultaneous linear equation and the candidate values of the solutions of the I decision variables from each of the J first Lagrange coefficients updated by the latest loop processing. More specifically, the update unit 30 substitutes a value expressed by equation (18) as the J first Lagrange coefficients (λⱼ[n+1]) in the n+1-th loop processing.

$${λ}_{j} [ n + 1 ] = {λ}_{j} [ n ] - μ \cdot ( {\sum }_{i} {A}_{j , i} \cdot {x}_{i} [ n + 1 ] - {B}_{j} ) \qquad ( 18 )$$

Furthermore, more specifically, the update unit 30 subtracts a value corresponding to an error between the corresponding alternative equation and the candidate values of the solutions of the I decision variables from each of the K second Lagrange coefficients updated by the latest loop processing. More specifically, the update unit 30 substitutes a value expressed by equation (19) as the K second Lagrange coefficients (λ′ₖ[n+1]) in the n+1-th loop processing.

$${λ}_{k}^{′} [ n + 1 ] = {λ}_{k}^{′} [ n ] - μ \cdot ( {\sum }_{i} {C}_{k , i} \cdot {x}_{i} [ n + 1 ] - {z}_{k} [ n + 1 ] ) \qquad ( 19 )$$

Furthermore, more specifically, the update unit 30 increases the penalty coefficient updated by the latest loop processing. More specifically, the update unit 30 substitutes a value expressed by equation (20) as a penalty (μ[n+1]) in the n+1-th loop processing.

μ[n+1]=α·μ[n] (20)

Note that α in equation (20) represents a predetermined value, and is a positive real number.

Subsequently, in S26, the update unit 30 adds 1 to n. Furthermore, when processing in S26 is ended, the update unit 30 returns the processing to S18, and repeats the processing from S18 to S26 until the end condition of S20 is reached. In a case where the end condition has been reached in S20 (Yes in Step S20), the update unit 30 advances the processing to S27.

In S27, in a case where the candidate values of the solutions of the I decision variables acquired in S19 satisfy the linear equality constraint and the linear inequality constraint, the output unit 34 outputs the candidate values of the solutions of the I decision variables as a solution to the solution target 0-1 integer non-convex quadratic programming problem. Furthermore, in a case where the candidate values of the solutions of the I decision variables acquired in S19 do not satisfy the linear equality constraint and the linear inequality constraint, the output unit 34 outputs information indicating that the solution to the solution target 0-1 integer non-convex quadratic programming problem cannot be calculated.

The above-described solver apparatus 10 according to the first embodiment alternately repeats the first processing of acquiring a solution to the 0-1 integer non-convex quadratic programming problem that does not include the constraint condition, and the second processing of acquiring the solution to the convex quadratic function. A solver such as an Ising machine can easily acquire a good solution for the 0-1 integer non-convex quadratic programming problem that does not include the constraint condition. Furthermore, the convex quadratic function can very easily acquire an optimal solution by solving a linear equation. Consequently, by repeating the first processing and the second processing, the solver apparatus 10 can efficiently calculate a good solution to the 0-1 integer non-convex quadratic programming problem including the linear constraint condition.

Furthermore, the solver apparatus 10 according to the first embodiment calculates the solutions of I decision variables using an augmented Lagrange function obtained by adding the J first Lagrange terms, the K second Lagrange terms, and the penalty term to the objective function. The J first Lagrange terms and the K second Lagrange terms function to cancel an inclination of the objective function around the constraint. Consequently, the solver apparatus 10 according to the first embodiment can acquire a solution that satisfies the constraint condition without making the penalty coefficient included in the penalty term larger than P_{i, i′} and Qᵢ that are coefficients included in the objective function. Consequently, the solver apparatus 10 according to the first embodiment can use computational performance of the first solver 26 to find a good solution instead of acquiring a feasible solution. Consequently, the solver apparatus 10 can increase a probability that a good solution is acquired.

Furthermore, the solver apparatus 10 according to the first embodiment updates the first Lagrange coefficients, the second Lagrange coefficients, and the penalty coefficient by simple computation. Consequently, the solver apparatus 10 can easily update the first Lagrange coefficients, the second Lagrange coefficients, and the penalty coefficient.

### Second Embodiment

A solver apparatus 10 according to the second embodiment calculates a solution to a problem that includes a linear constraint condition and is a combination of 0-1 integer non-convex quadratic programming and continuous convex programming. In the second embodiment, identical or corresponding coefficients, variables, functional blocks, and steps to those in the first embodiment will be assigned the same symbols or reference signs, description thereof will be omitted, and differences will be mainly described.

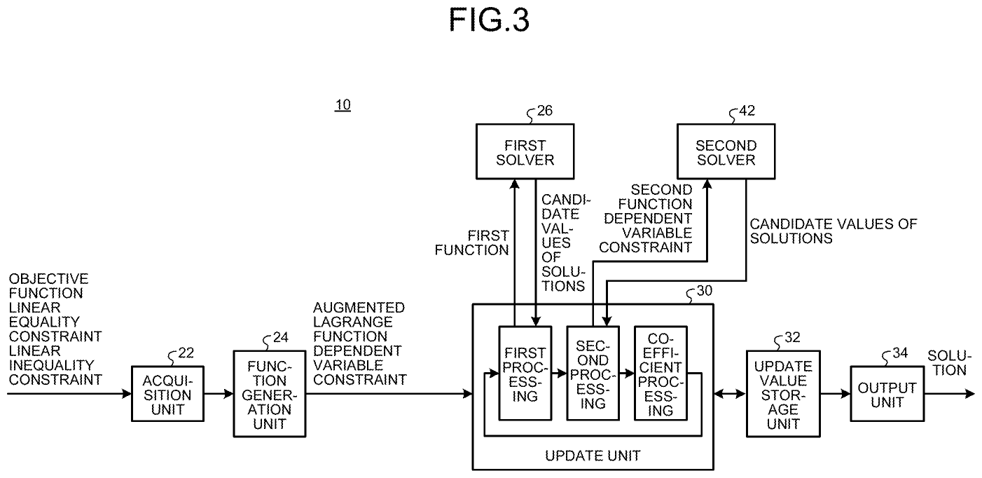

FIG. 3 is a diagram illustrating a functional configuration of the solver apparatus 10 according to the second embodiment.

The solver apparatus 10 according to the second embodiment calculates a solution to a problem that minimizes an objective function obtained by adding an integer non-convex quadratic function and a continuous convex function under a condition that satisfies the linear constraint. For example, the continuous convex function is a continuous convex quadratic function. The integer non-convex quadratic function includes I first decision variables that are each zero or one. The continuous convex function includes M (M is an integer equal to or more than two) second decision variables that are each a real number.

The linear constraint includes a linear equality constraint and a linear inequality constraint. The linear equality constraint is expressed by J simultaneous linear equations. Each of the J simultaneous linear equations includes at least one of the I first decision variables and the M second decision variables as a variable. Note that the linear constraint may not include the linear equality constraint. In this case, the solver apparatus 10 handles J simultaneous linear equations assuming J=0.

The linear inequality constraint is expressed by K simultaneous linear inequalities. Each of the K simultaneous linear inequalities includes at least one of the I first decision variables and the M second decision variables as a variable.

The solver apparatus 10 according to the second embodiment further includes a second solver 42 compared to the configuration of the first embodiment.

The second solver 42 calculates a solution to a continuous convex programming problem under a condition that constrains a range of the variable. When, for example, the continuous convex function included in the objective function is the continuous convex quadratic function, the second solver 42 calculates the solution to the continuous convex quadratic programming problem under the condition that constrains the range of the variable. The second solver 42 is implemented when, for example, a processor or a computer implemented as the solver apparatus executes a solving program for the continuous convex programming problem. Furthermore, the second solver 42 may be provided by a server or the like. In this case, the second solver 42 may be implemented outside the solver apparatus 10. As an example, the second solver 42 can be implemented when a computer executes a solver program called an Operator Splitting Quadratic Program (OSQP). In a case where the second solver 42 is implemented outside the solver apparatus 10, the solver apparatus 10 gives the continuous convex function (e.g., continuous convex quadratic function) to the second solver 42 via a network, and acquires candidate values of solutions from the second solver 42 via the network.

The acquisition unit 22 acquires the objective function, the linear equality constraint, and the linear inequality constraint. The function generation unit 24 generates an augmented Lagrange function and a dependent variable constraint based on the information acquired by the acquisition unit 22.

The augmented Lagrange function is a function generated to efficiently calculate a solution. The augmented Lagrange function includes the I first decision variables, the M second decision variables, and K dependent variables.

The update unit 30 repeats first processing, second processing, and coefficient processing until a preset end condition is reached.

The first processing is processing of acquiring candidate values of solutions of the I first decision variables that minimize a first function. The update unit updates the candidate values of the solutions of the I first decision variables every time the first processing is executed.

The first function is a function including the I first decision variables generated based on the augmented Lagrange function. The first function is a function obtained by substituting candidate values of the M second decision variables and candidate values of solutions of the K dependent variables into the augmented Lagrange function. The candidate values of the solutions of the M second decision variables and the candidate values of the solutions of the K dependent variables are values based on the latest second processing. Furthermore, in a case where the initial first processing is executed before the initial second processing is executed, the candidate values of the solutions of the M second decision variables and the candidate values of the solutions of the K dependent variables are preset initial values.

The first function is an integer non-convex quadratic function. Therefore, in the first processing, the update unit 30 gives a problem that minimizes the first function to a first solver 26, and acquires the candidate values of the solutions of the I first decision variables as the solution to the problem from the first solver 26.

The second processing is processing of acquiring the candidate values of the solutions of the M second decision variables and the candidate values of the solutions of the K dependent variables that minimize a second function under a condition that satisfies the dependent variable constraint expressed by K inequalities. The update unit 30 updates the candidate values of the solutions of the M second decision variables and the candidate values of the solutions of the K dependent variables every time the second processing is executed.

The second function is a function including the M second decision variables and the K dependent variables generated based on the augmented Lagrange function. The second function is a function obtained by substituting the candidate values of the solutions of the I first decision variables into the augmented Lagrange function. The candidate values of the solutions of the I first decision variables are values updated based on the latest first processing. Furthermore, in a case where the initial second processing is executed before the initial first processing is executed, the candidate values of the solutions of the K first decision variables are preset initial values.

The K inequalities correspond to the K dependent variables. Each of the K inequalities expresses a minimum value that a corresponding dependent variable can take.

The second function is the continuous convex function. For example, the second function is the continuous convex quadratic function. Hence, in the second processing, the update unit 30 gives a problem that minimizes the second function to the second solver 42 under the condition of the K inequalities, and acquires the candidate values of the solutions of the M second decision variables and the candidate values of the solutions of the K dependent variables as the solution to the problem from the second solver 42.

The coefficient processing is processing of updating each of a plurality of coefficients included in the augmented Lagrange function. The update unit 30 updates each of the plurality of coefficients included in the augmented Lagrange function based on the candidate values of the solutions of the I first decision variables updated based on the latest first processing, the candidate values of the solutions of the M second decision variables updated based on the latest second processing, and the candidate values of the solutions of the K dependent variables updated based on the latest second processing. Note that each of the plurality of coefficients in the augmented Lagrange function takes a preset initial value before the initial first processing and the initial second processing are executed.

The update value storage unit 32 stores the candidate values of the solutions of the I first decision variables, the candidate values of the solutions of the M second decision variables, the candidate values of the solutions of the K dependent variables, and the plurality of coefficients included in the augmented Lagrange function. The update unit 30 updates the corresponding values stored in the update value storage unit 32 every time the first processing, the second processing, and the coefficient processing are executed.

When the update unit 30 repeats the first processing, the second processing, and the coefficient processing, and thereby the preset end condition is reached, an output unit 34 outputs the candidate values of the solutions of the I first decision variables and the candidate values of the solutions of the M second decision variables as the solution to the problem.

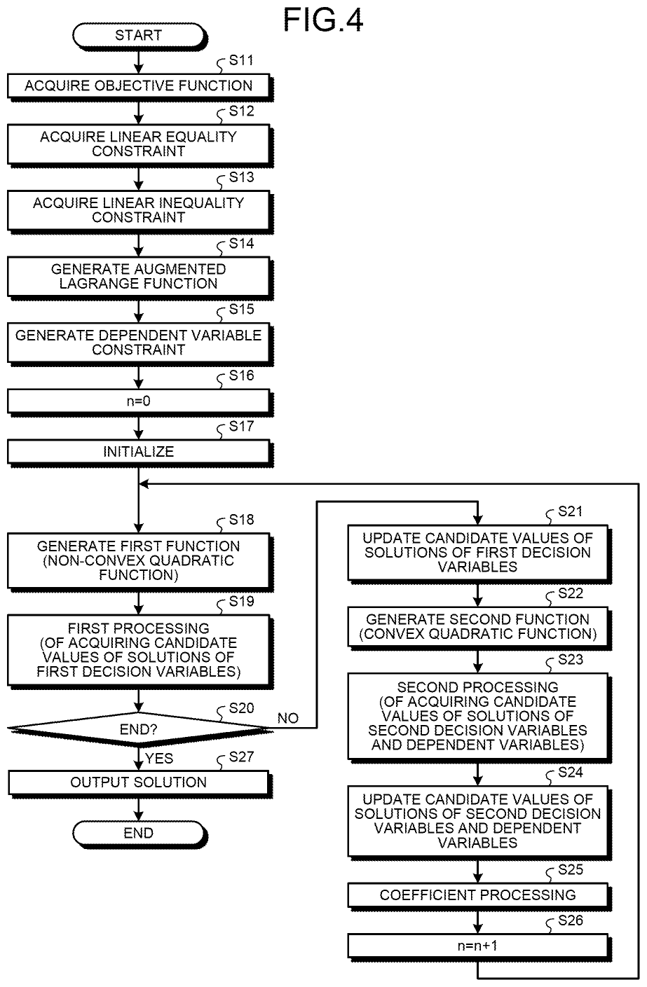

FIG. 4 is a flowchart illustrating a flow of processing of the solver apparatus 10 according to the second embodiment. The solver apparatus 10 executes the processing according to the flow illustrated in FIG. 4.

First, in S11, the acquisition unit 22 acquires the objective function obtained by adding the integer non-convex quadratic function including the I first decision variables that are each zero or one, and the continuous convex function including the M second decision variables that are each a real number. The continuous convex function is, for example, the continuous convex quadratic function.

The I first decision variables and the M second decision variables are expressed by equation (21). The I first decision variables are xᵢ. The M second decision variables are yᵢ.

xᵢ,yₘ (21)

Note that the I first decision variables are zero or one, and therefore are the same as the I decision variables in the first embodiment. Hence, in the second embodiment, the I first decision variables are represented as xᵢ.

Each of the M second decision variables is a real number, and is constrained as in equation (22).

yₘϵ [symbol] (22)

The objective function is expressed as in equation (23).

$${\sum }_{i , {i}^{′}} {x}_{i} \cdot {P}_{i , {i}^{′}} \cdot {x}_{{i}^{′}} + {\sum }_{i} {Q}_{i} \cdot {x}_{i} + R ( {y}_{m} ) \qquad ( 23 )$$

Where, m is an integer equal to or more than one and equal to or less than M, and represents an index to be allocated to each of the M second decision variables. That is, of the M second decision variables, y₁ represents a first second decision variable, y₂ represents a second second decision variable, y_{M} represents an M-th second decision variable, and yₘ represents an m-th second decision variable.

R(yₘ) represents the continuous convex function. R(yₘ) is, for example, the continuous convex quadratic function.

Subsequently, in S12, an acquisition unit 22 acquires the linear equality constraint. More specifically, the linear equality constraint is expressed by the J simultaneous linear equations in equation (24).

$${\sum }_{i} {A}_{j , i} \cdot {x}_{i} + {\sum }_{m} {E}_{j , m} \cdot {y}_{m} = {B}_{j} \qquad ( 24 )$$

Where, E_{j, m} represents a coefficient to be multiplied on an m-th second decision variable in a j-th simultaneous linear equation. E_{j, m} represents a real number. Note that the acquisition unit 22 may not acquire the linear equality constraint. In a case where the linear equality constraint is not acquired, the solver apparatus 10 does not execute computation on j assuming J=0.

Subsequently, in S13, the acquisition unit 22 acquires the linear inequality constraint. More specifically, the linear inequality constraint is expressed by K simultaneous linear inequalities in equation (25).

$${\sum }_{i} {C}_{k , i} \cdot {x}_{i} + {\sum }_{m} {F}_{k , m} \cdot {y}_{m} \leq {D}_{k} \qquad ( 25 )$$

Where, F_{k, m} represents a coefficient to be multiplied on the m-th second decision variable in a k-th simultaneous linear inequality. F_{k, m} represents a real number.

Subsequently, in S14, a function generation unit 24 generates the augmented Lagrange function based on the objective function, the J simultaneous linear equations, and the K simultaneous linear inequalities. The augmented Lagrange function is expressed by equation (26).

$$L ( x , y , z , λ , {λ}^{′} , μ ) = {\sum }_{i , {i}^{′}} {x}_{i} \cdot {P}_{i , {i}^{′}} \cdot {x}_{{i}^{′}} + {\sum }_{i} {Q}_{i} \cdot {x}_{i} - {\sum }_{j} {λ}_{j} \cdot ( {\sum }_{i} {A}_{j , i} \cdot {x}_{i} + {\sum }_{m} {E}_{j , m} \cdot {y}_{m} - {B}_{j} ) - {\sum }_{k} {λ}_{k}^{′} \cdot ( {\sum }_{i} {C}_{k , i} \cdot {x}_{i} + {\sum }_{m} {F}_{k , m} \cdot {y}_{m} - {z}_{k} ) + \frac{μ}{2} ( {\sum }_{j} {( {\sum }_{i} {A}_{j , i} \cdot {x}_{i} + {\sum }_{m} {E}_{j , m} \cdot {y}_{m} - {B}_{j} )}^{2} + {\sum }_{k} {( {\sum }_{i} {C}_{k , i} \cdot {x}_{i} + {\sum }_{m} {F}_{k , m} \cdot {y}_{m} - {z}_{k} )}^{2} ) + R ( {y}_{m} ) \qquad ( 26 )$$

The augmented Lagrange function includes an objective function term, J first Lagrange terms, K second Lagrange terms, and a penalty term.

The objective function term includes the objective function. The objective function term is expressed by equation (27).

$${\sum }_{i , {i}^{′}} {x}_{i} \cdot {P}_{i , {i}^{′}} \cdot {x}_{{i}^{′}} + {\sum }_{i} {Q}_{i} \cdot {x}_{i} + R ( {y}_{m} ) \qquad ( 27 )$$

The J first Lagrange terms correspond to the J simultaneous linear equations. The equation obtained by summing the J first Lagrange terms is expressed by equation (28).

$$- {\sum }_{j} {λ}_{j} \cdot ( {\sum }_{i} {A}_{j , i} \cdot {x}_{i} + {\sum }_{m} {E}_{j , m} \cdot {y}_{m} - {B}_{j} ) \qquad ( 28 )$$

Where, each of the J first Lagrange terms is a function obtained by multiplying by a corresponding first Lagrange coefficient of the J first Lagrange coefficients a function expressing an error between a corresponding simultaneous linear equation of the J simultaneous linear equations, and the candidate values of the solutions of the I first decision variables and the candidate values of the solutions of the M second decision variables. That is, each of the J first Lagrange terms is a function that is 0 when the candidate values of the solutions of the I first decision variables and the candidate values of the solutions of the M second decision variables satisfy the corresponding linear equality constraint, and is shifted in a minus direction or a plus direction when the candidate values do not satisfy the corresponding linear equality constraint.

Note that −1 is multiplied at a head in equation (28). However, −1 may not be multiplied on equation (28).

The K second Lagrange terms correspond to the K simultaneous linear inequalities. An equation obtained by summing the K second Lagrange terms is expressed by equation (29).

$$- {\sum }_{k} {λ}_{k}^{′} \cdot ( {\sum }_{i} {C}_{k , i} \cdot {x}_{i} + {\sum }_{m} {F}_{k , m} \cdot {y}_{m} - {z}_{k} ) \qquad ( 29 )$$

The function generation unit 24 sets K alternative equations. Each of the K alternative equations is an equation obtained by replacing an inequality sign of a corresponding simultaneous linear inequality of the K simultaneous linear inequalities with an equal sign, and replacing a constant term with a corresponding dependent variable of the K dependent variables. In a case of an example of equation (29), a k-th alternative equation is an equation obtained by replacing an inequality sign of equation (25) with an equal sign and replacing Dₖ with zₖ.

Each of the K second Lagrange terms is a function obtained by multiplying by a corresponding second Lagrange coefficient of the K second Lagrange coefficients a function expressing an error between a corresponding alternative equation of the K alternative equations, and the candidate values of the solutions of the I first decision variables and the candidate values of the solutions of the M second decision variables. That is, each of the K second Lagrange terms is a function that is 0 when the candidate values of the solutions of the I first decision variables and the candidate values of the solutions of the M second decision variables satisfy the corresponding alternative equation, and is shifted in the minus direction or the plus direction when the candidate values do not satisfy the corresponding alternative equation.

Note that −1 is multiplied at a head in equation (29). However, −1 may not be multiplied on equation (29).

The penalty term is expressed by equation (30).

$$+ \frac{μ}{2} ( {\sum }_{j} {( {\sum }_{i} {A}_{j , i} \cdot {x}_{i} + {\sum }_{m} {E}_{j , m} \cdot {y}_{m} - {B}_{j} )}^{2} + {\sum }_{k} {( {\sum }_{i} {C}_{k , i} \cdot {x}_{i} + {\sum }_{m} {F}_{k , m} \cdot {y}_{m} - {z}_{k} )}^{2} ) \qquad ( 30 )$$

Where, the penalty term is a function obtained by multiplying the sum of the J first distance functions and the K second distance functions by the penalty coefficient. Each of the J first distance functions is a function expressing a distance (first distance) between a corresponding simultaneous linear equation of the J simultaneous linear equations, and the candidate values of the solutions of the I first decision variables and the candidate values of the solutions of the M second decision variables. In a case of an example of equation (30), each of the J first distance functions is a function obtained by squaring an error between the corresponding simultaneous linear equation, and the candidate values of the solutions of the I first decision variables and the candidate values of the solutions of the M second decision variables.

Each of the K second distance functions is a function expressing a distance (second distance) between a corresponding alternative equation of the K alternative equations, and the candidate values of the solutions of the I first decision variables and the candidate values of the solutions of the M second decision variables. For example, in the case of the example of equation (30), each of the K second distance functions is a function obtained by squaring an error between the corresponding alternative equation, and the candidate values of the solutions of the I first decision variables and the candidate values of the solutions of the M second decision variables. That is, the penalty term is a function that is shifted in the plus direction as the sum of the first distance and the second distance becomes plus.

Note that ½ is multiplied at a head in equation (30). However, equation (30) may be multiplied by a value other than ½ as long as the value is a real number larger than 0.

Subsequently, in S15, the function generation unit 24 generates the dependent variable constraint expressed by the K inequalities. The dependent variable constraint is expressed by equation (31).

zₖ≤Dₖ (31)

Where, each of the K inequalities expresses that a corresponding dependent variable of the K dependent variables is equal to or less than a constant term in a corresponding simultaneous linear inequality of the K simultaneous linear inequalities. In a case of an example of equation (31), each of the K inequalities is an inequality obtained by replacing the left side of equation (25) with zₖ.

Subsequently, in S16, the update unit 30 initializes n to 0.

Subsequently, in S17, prior to the initial first processing, the initial second processing, and initial coefficient processing, the update unit 30 substitutes a predetermined initial value into each of the candidate values of the solutions of the I first decision variables, each of the candidate values of the solutions of the M second decision variables, each of the candidate values of the solutions of the K dependent variables, each of the J first Lagrange coefficients, each of the K second Lagrange coefficients, and the penalty coefficient.

In this example, yₘ[n] represents the candidate values of the solutions of the M second decision variables after n-th loop processing. Note that yₘ

represents an initial value of yₘ[n]. For example, the update unit 30 initializes each of these values as in equation (32).

$${x}_{i} [ n ] = 0 , {λ}_{j} [ n ] = 0 , {λ}_{k}^{′} [ n ] = 0 , μ [ n ] = {μ}_{0} , \qquad ( 32 )$$

$${y}_{m} [ n ] , {z}_{k} [ n ] = {arg}_{y , z} min L ( x [ n ] , y , z , λ [ n ] , {λ}^{′} [ n ] , μ [ n ] )$$

$$subject to {z}_{k} \leq {D}_{k}$$

Note that arg_{y, z} is a function of acquiring values of y and z. The update unit 30 may calculate zₖ[n] and yₘ[n] in equation (32) by computation as long as zₖ[n] and yₘ[n] can be calculated by computation, may accept z k [n] and yₘ[n] satisfying equation (32) from a user, or acquire zₖ[n] and yₘ[n] from another apparatus. Furthermore, similarly to S22 and S23 described later, the update unit 30 may generate the second function, give the problem that minimizes the generated second function to the second solver 42, and acquire zₖ[n] and yₘ[n] in equation (32) as the solution to the problem from the second solver 42.

In S18, the update unit 30 generates the first function including the I first decision variables based on the augmented Lagrange function. The first function generated by n+1-th loop processing is expressed by equation (33).

$$L ( x , y [ n ] , z [ n ] , λ [ n ] , {λ}^{′} [ n ] , μ [ n ] ) = \{ {P}_{i , {i}^{′}} + \frac{μ}{2} \cdot {\sum }_{j} {A}_{j , i} \cdot {A}_{j , {i}^{′}} + \frac{μ}{2} \cdot {\sum }_{k} {C}_{k , i} \cdot {C}_{k , {i}^{′}} \} \cdot {x}_{{i}^{′}} + {\sum }_{i} \{ {Q}_{i} + {\sum }_{j} ( - {λ}_{j} - μ \cdot {B}_{j} + μ \cdot {\sum }_{m} {E}_{j , m} \cdot {y}_{m} ) \cdot {A}_{j , i} + {\sum }_{k} ( - {λ}_{k}^{′} - μ \cdot {z}_{k} + μ \cdot {\sum }_{m} {F}_{k , m} \cdot {y}_{m} ) \cdot {C}_{k , i} \} \cdot {x}_{i} \qquad ( 33 )$$

That is, the first function generated by the n+1-th loop processing is a function obtained by substituting into the augmented Lagrange function of equation (26) yₘ[n] that represents the candidate values of the solutions of the M second decision variables, zₖ[n] that represents the candidate values of the solutions of the K dependent variables, λⱼ[n] that represents the J first Lagrange coefficients, λ′ₖ[n] that represents the K second Lagrange coefficients, and μ[n] that represents the penalty coefficient after latest loop processing (n-th loop processing). The first function is the integer non-convex quadratic function including the I first decision variables. Note that, in the first loop processing, y m [n], zₖ[n], λⱼ[n], λ′ₖ[n], and μ[n] after the latest loop processing take the initial values substituted in S17.

Subsequently, in S19, the update unit 30 executes the first processing. That is, the update unit 30 acquires the candidate values of the solutions of the I first decision variables that minimize the first function. For example, the update unit 30 executes a function expressed by equation (34).

argₓ min L(x,y[n],z[n],λ[n],λ′[n],μ[n]) (34)

The update unit 30 gives the problem that minimizes the first function to the first solver 26 by executing equation (34), and acquires the candidate values of the solutions of the I first decision variables as the solution to the problem from the first solver 26.

Subsequently, in S20, the update unit 30 determines whether or not an end condition has been reached. In a case where the end condition has been reached, the update unit 30 advances the processing to S27. In a case where the end condition is not reached, the update unit 30 advances the processing to S21.

Subsequently, in S21, the update unit 30 updates each of the candidate values of the solutions of the I first decision variables stored in the update value storage unit 32.

In S22, the update unit 30 generates the second function including the M second decision variables and the K dependent variables based on the augmented Lagrange function. The second function generated by the n+1-th loop processing is expressed by equation (35).

$$L ( x [ n + 1 ] , y , z , λ [ n ] , {λ}^{′} [ n ] , μ [ n ] ) = - {\sum }_{j} {λ}_{j} \cdot ( {\sum }_{i} {A}_{j , i} \cdot {x}_{i} + {\sum }_{m} {E}_{j , m} \cdot {y}_{m} - {B}_{j} ) - {\sum }_{k} {λ}_{k}^{′} \cdot ( {\sum }_{i} {C}_{k , i} \cdot {x}_{i} + {\sum }_{m} {F}_{k , m} \cdot {y}_{m} - {z}_{k} ) + \frac{μ}{2} \cdot {\sum }_{j} {( {\sum }_{i} {A}_{j , i} \cdot {x}_{i} + {\sum }_{m} {E}_{j , m} \cdot {y}_{m} - {B}_{j} )}^{2} + \frac{μ}{2} \cdot {\sum }_{k} {( {\sum }_{i} {C}_{k , i} \cdot {x}_{i} + {\sum }_{m} {F}_{k , m} \cdot {y}_{m} - {z}_{k} )}^{2} + R ( {y}_{m} ) = \frac{μ}{2} \cdot {\sum }_{j} {( {\sum }_{i} {A}_{j , i} \cdot {x}_{i} + {\sum }_{m} {E}_{j , m} \cdot {y}_{m} - {B}_{j} - \frac{{λ}_{m}}{μ} )}^{2} + \frac{μ}{2} \cdot {\sum }_{k} {( {\sum }_{i} {C}_{k , i} \cdot {x}_{i} + {\sum }_{m} {F}_{k , m} \cdot {y}_{m} - {z}_{k} - \frac{{λ}_{k}^{′}}{μ} )}^{2} + R ( {y}_{m} ) \qquad ( 35 )$$

That is, the second function generated by the n+1-th loop processing is a function obtained by substituting into the augmented Lagrange function of equation (26) xᵢ[n+1] that represents the candidate values of the solutions of the I first decision variables updated in latest step S21, λⱼ[n] that represents the J first Lagrange coefficients after latest loop processing (n-th loop process), λ′ₖ[n] that represents the K second Lagrange coefficients, and μ[n] that represents the penalty coefficient. Note that, in the first loop processing, λⱼ[n], λ′ₖ[n], and μ[n] updated by the latest loop processing take the initial values substituted in S17.

Subsequently, in S23, the update unit 30 executes the second processing. That is, the update unit 30 acquires the candidate values of the solutions of the M second decision variables and the candidate values of the solutions of the K dependent variables that minimize the second function under a condition that satisfies the dependent variable constraint expressed by the K inequalities. For example, the update unit 30 gives the problem that minimizes the second function to the second solver 42, and acquires the candidate values of the solutions of the M second decision variables and the candidate values of the solutions of the I first decision variables as the solution to the problem from the second solver 42. For example, the update unit 30 executes a function expressed by equation (36).

arg_{y,z} min L(x[n+1],y,z,λ[n],λ′[n],μ[n]) subject to zₖ≤Dₖ (36)

Note that arg_{y, z} is a function of acquiring values of y and z.

Subsequently, in S24, the update unit 30 updates each of the candidate values of the solutions of the M second decision variables and each of the candidate values of the solutions of the K dependent variables stored in the update value storage unit 32.

Subsequently, in S25, the update unit 30 executes the coefficient processing. That is, the update unit 30 updates the J first Lagrange coefficients, the K second Lagrange coefficients, and the penalty coefficient stored in the update value storage unit 32.

More specifically, the update unit 30 subtracts a value corresponding to an error between the corresponding simultaneous linear equation, and the candidate values of the solutions of the I first decision variables and the candidate values of the solutions of the M second decision variables from each of the J first Lagrange coefficients updated by the latest loop processing. More specifically, the update unit 30 substitutes a value expressed by equation (37) as the J first Lagrange coefficients (λⱼ[n+1]) in the n+1-th loop processing.

$${λ}_{j} [ n + 1 ] = {λ}_{j} [ n ] - μ \cdot ( {\sum }_{i} {A}_{j , i} \cdot {x}_{i} + {\sum }_{m} {E}_{j , m} \cdot {y}_{m} - {B}_{j} ) \qquad ( 37 )$$

Furthermore, more specifically, the update unit 30 subtracts a value corresponding to an error between the corresponding alternative equation, and the candidate values of the solutions of the I first decision variables and the candidate values of the solutions of the M second decision variables from each of the K second Lagrange coefficients updated by the latest loop processing. More specifically, the update unit 30 substitutes a value expressed by equation (38) as the K second Lagrange coefficients (λ′ₖ[n+1]) in the n+1-th loop processing.

$${λ}_{k}^{′} [ n + 1 ] = {λ}_{k}^{′} [ n ] - μ \cdot ( {\sum }_{i} {C}_{k , i} \cdot {x}_{i} + {\sum }_{m} {F}_{k , m} \cdot {y}_{m} - {z}_{k} ) \qquad ( 38 )$$

Furthermore, more specifically, the update unit 30 increases the penalty coefficient updated by the latest loop processing. More specifically, the update unit 30 substitutes a value expressed by equation (39) as a penalty (μ[n+1]) in the n+1-th loop processing.

μ[n+1]=α·μ[n] (39)

Subsequently, in S26, the update unit 30 adds 1 to n. Furthermore, when processing in S26 is ended, the update unit 30 returns the processing to S18, and repeats the processing from S18 to S26 until the end condition of S20 is reached. In a case where the end condition has been reached in S20 (Yes in Step S20), the update unit 30 advances the processing to S27.

In S27, in a case where the candidate values of the solutions of the I first decision variables acquired in S19 and the candidate values of the solutions of the M second decision variables acquired in S23 satisfy the linear equality constraint and the linear inequality constraint, the output unit 34 outputs the candidate values of the solutions of the I first decision variables and the candidate values of the solutions of the M second decision variables as the solution to the solution target 0-1 integer non-convex quadratic programming problem. Furthermore, in a case where the candidate values of the solutions of the I first decision variables and the candidate values of the solutions of the M second decision variables do not satisfy the linear equality constraint and the linear inequality constraint, the output unit 34 outputs information indicating that the solution to the solution target 0-1 integer non-convex quadratic programming problem cannot be calculated.

The above-described solver apparatus 10 according to the second embodiment alternately repeats the first processing of acquiring the solution to the 0-1 integer non-convex quadratic programming problem that does not include the constraint condition, and the second processing of acquiring the solution to the continuous convex function. A solver such as an Ising machine can easily acquire a good solution for the 0-1 integer non-convex quadratic programming problem that does not include the constraint condition. Furthermore, an existing solver can easily acquire a good solution for the continuous convex programming problem. Consequently, by repeating the first processing and the second processing, the solver apparatus 10 can efficiently calculate a good solution to a problem that is a combination of the 0-1 integer non-convex quadratic programming problem that includes the linear constraint condition, and a continuous convex programming problem.

Furthermore, the above-described solver apparatus 10 according to the second embodiment calculates the solutions of I first decision variables using an augmented Lagrange function obtained by adding the J first Lagrange terms, the K second Lagrange terms, and the penalty term to the objective function. The J first Lagrange terms and the K second Lagrange terms function to cancel an inclination of the objective function around the constraint. Consequently, the solver apparatus 10 according to the second embodiment can acquire a solution that satisfies the constraint condition without making the penalty coefficient included in the penalty term larger than P_{i, i′} and Qᵢ that are coefficients included in the objective function. Consequently, the solver apparatus 10 according to the second embodiment can use computational performance of the first solver 26 to find a good solution instead of acquiring a feasible solution. Consequently, the solver apparatus 10 can increase a probability that a good solution is acquired.

Furthermore, the solver apparatus 10 according to the second embodiment updates the first Lagrange coefficients, the second Lagrange coefficients, and the penalty coefficient by simple computation. Consequently, the solver apparatus 10 can easily update the first Lagrange coefficients, the second Lagrange coefficients, and the penalty coefficient.

### MODIFIED EXAMPLE

The K second Lagrange terms included in the augmented Lagrange function according to the first embodiment may be expressed as in equation (40).

$$- {\sum }_{k} {λ}_{k}^{′} \cdot φ ( {\sum }_{i} {C}_{k , i} \cdot {x}_{i} - {z}_{k} ) \qquad ( 40 )$$

Where, φ(x) in equation (40) represents an activation function. The activation function is, for example, a ReLU function as expressed in equation (41).

$$φ ( x ) = \{ \begin{matrix}x & if x \geq 0 \\ 0 & if x < 0\end{matrix} \qquad ( 41 )$$

φ(x) switches whether to output x as it is or to output 0 according to whether x is a threshold or more or x is smaller than the threshold. The threshold may be any value.

Furthermore, in such a case, during the coefficient processing in S25, the update unit 30 updates the second Lagrange coefficient using the activation function as expressed in equation (42).

$${λ}_{k}^{′} [ n + 1 ] = {λ}_{k}^{′} [ n ] - μ \cdot φ ( {\sum }_{i} {C}_{k , i} \cdot {x}_{i} [ n + 1 ] - {z}_{k} [ n + 1 ] ) \qquad ( 42 )$$

Such an augmented Lagrange function is effective in a case where the first solver 26 is a solver that switches whether or not to search for an optimum value according to values of the decision variables. Furthermore, the activation function may be applied to the second Lagrange terms of the augmented Lagrange function according to the second embodiment.

Hardware Configuration

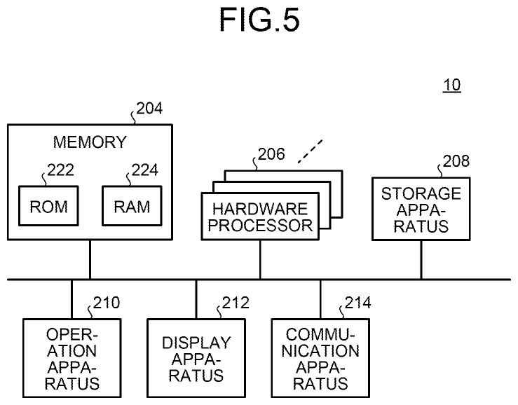

FIG. 5 is a hardware block diagram of the solver apparatus 10. As an example, the solver apparatus 10 is implemented by a hardware configuration similar to that of a general computer (information processing apparatus) as illustrated in FIG. 5. The solver apparatus 10 may be implemented as one computer or server as illustrated in FIG. 5, or may be implemented as a plurality of computers or servers operating in cooperation with each other. Furthermore, the solver apparatus 10 may employ a configuration partially including a dedicated hardware circuit.

The solver apparatus 10 includes a memory 204, one or more hardware processors 206, a storage apparatus 208, an operation apparatus 210, a display apparatus 212, and a communication apparatus 214. Each unit is connected by a bus.

The memory 204 includes, for example, a ROM 222 and a RAM 224. The ROM 222 unrewritably stores programs, various setting information, and the like used for controlling the solver apparatus 10. The RAM 224 is a volatile storage medium such as a Synchronous Dynamic Random Access Memory (SDRAM). The RAM 224 functions as a working area of the one or more hardware processors 206.

The one or more hardware processors 206 are connected to the memory 204 (the ROM 222 and the RAM 224) via the bus. Each of the one or more hardware processors 206 may be, for example, a Central Processing Unit (CPU) or may be a hardware circuit for computation.

The one or more hardware processors 206 execute various processing in cooperation with various programs stored in advance in the ROM 222 or the storage apparatus 208 using a predetermined area of the RAM 224 as a working area, and integrally control the operation of each unit constituting the solver apparatus 10. Furthermore, the one or more hardware processors 206 control the operation apparatus 210, the display apparatus 212, the communication apparatus 214, and the like in cooperation with a program stored in advance in the ROM 222 or the storage apparatus 208.

The storage apparatus 208 is a rewritable recording apparatus including, for example, a semiconductor storage medium such as a flash memory and a magnetically or optically recordable storage medium. The storage apparatus 208 stores programs, various setting information, and the like used for controlling the solver apparatus 10.

The operation apparatus 210 is an input device such as a mouse and a keyboard. The operation apparatus 210 accepts information input by a user's operation, and outputs the accepted information to the one or more hardware processors 206.

The display apparatus 212 displays information to the user. The display apparatus 212 receives the information and the like from the one or more hardware processors 206, and displays the received information. Note that, in a case where information is output to the communication apparatus 214, the storage apparatus 208, or the like, the solver apparatus 10 may not include the display apparatus 212. The communication apparatus 214 communicates with an external device, and transmits and receives information via a network or the like.

The program executed by the solver apparatus 10 according to this embodiment is recorded as a file in an installable format or an executable format in a computer-readable recording medium such as a CD-ROM, a Flexible Disk (FD), a CD-R, or a Digital Versatile Disk (DVD), and is provided.

Furthermore, the program executed by the solver apparatus 10 according to the present embodiment may be configured to be stored in a computer connected to a network such as the Internet, downloaded via the network, and thereby provided. Furthermore, the program executed by the solver apparatus 10 according to the present embodiment may be configured to be provided or distributed via the network such as the Internet. Furthermore, the program executed by the solver apparatus 10 according to the present embodiment may be configured to be incorporated in a ROM or the like in advance and provided.

The program for causing the information processing apparatus to function as the solver apparatus 10 employs a module configuration including, for example, an acquisition module, a function generation module, an update module, and an output module. Furthermore, the program may include a first solver module and a second solver module. When this program is executed by the one or more hardware processors 206, each module is loaded into the RAM 224 of the memory 204 to cause the one or more hardware processors 206 to function as the acquisition unit 22, the function generation unit 24, the update unit 30, and the output unit 34. Furthermore, this program may cause the one or more hardware processors 206 to function as the first solver 26 and the second solver 42. Note that part or all of these components may be configured as hardware.

Although some embodiments of the present invention have been described, these embodiments have been presented as examples, and are not intended to limit the scope of the invention. These novel embodiments can be carried out in various other forms, and various omissions, replacement, and changes can be made without departing from the gist of the invention. These embodiments and modifications thereof are included in the scope and the gist of the invention, and are included in the invention recited in the claims and the equivalent scope thereof.

What is claimed is:

1. A solver apparatus that calculates a solution to a problem under a condition, the problem minimizing an objective function that is a non-convex quadratic function including I (I is an integer equal to or more than two) decision variables that are each zero or one, and the condition satisfying J (J is an integer equal to or more than zero) simultaneous linear equations that each include at least one of the I decision variables as a variable and satisfying K (K is an integer equal to or more than one) simultaneous linear inequalities that each include at least one of the I decision variables as a variable, the solver apparatus comprising:
one or more hardware processors configured to function as:
an acquisition unit that acquires the objective function, the J simultaneous linear equations, and the K simultaneous linear inequalities;
an update unit that repeats first processing, second processing, and coefficient processing in predetermined order, the first processing acquiring candidate values of solutions of the I decision variables that minimize a first function including the I decision variables generated based on an augmented Lagrange function, the second processing acquiring candidate values of solutions of the K dependent variables that minimize a second function including K dependent variables generated based on the augmented Lagrange function, and the coefficient processing updating a coefficient included in the augmented Lagrange function; and
an output unit that outputs the candidate values of the solutions of the I decision variables as the solution to the problem when a preset end condition is reached by repeating the first processing, the second processing, and the coefficient processing, wherein
the augmented Lagrange function includes an objective function term including the objective function, J first Lagrange terms corresponding to the J simultaneous linear equations, K second Lagrange terms corresponding to the K simultaneous linear inequalities, and a penalty term.

2. The solver apparatus according to claim 1, wherein
each of the J first Lagrange terms is a function obtained by multiplying a function expressing an error by a corresponding first Lagrange coefficient of J first Lagrange coefficients, the error being an error between a corresponding simultaneous linear equation of the J simultaneous linear equations, and the candidate values of the solutions of the I decision variables,
each of the K second Lagrange terms is a function obtained by multiplying a function expressing an error by a corresponding second Lagrange coefficient of the K second Lagrange coefficients, the error being an error between an alternative equation and the candidate values of the solutions of the I decision variables, and the alternative equation being obtained by replacing an inequality sign of a corresponding simultaneous linear inequality of the K simultaneous linear inequalities with an equal sign and replacing a constant term with a corresponding dependent variable of the K dependent variables, and
the penalty term is a function obtained by multiplying a sum of J first distance functions and K second distance functions by a penalty coefficient, the J first distance functions each expressing a distance between a corresponding simultaneous linear equation and the candidate values of the solutions of the I decision variables, and the K second distance functions each expressing a distance between a corresponding alternative equation and the candidate values of the solutions of the I decision variables.

3. The solver apparatus according to claim 2, wherein
in the second processing, the update unit acquires the candidate values of the solutions of the K dependent variables of the second function under a condition that satisfies K inequalities, and
each of the K inequalities expresses that a corresponding dependent variable of the K dependent variables is equal to or less than a constant term in a corresponding simultaneous linear inequality of the K simultaneous linear inequalities.

4. The solver apparatus according to claim 3, wherein
the first function is a function obtained by substituting the candidate values of the solutions of the K dependent variables into the augmented Lagrange function, and
the second function is a function obtained by substituting the candidate values of the solutions of the I decision variables into the augmented Lagrange function.

5. The solver apparatus according to claim 4, wherein
in the coefficient processing, the update unit updates the J first Lagrange coefficients, the K second Lagrange coefficients, and the penalty coefficient as coefficients included in the augmented Lagrange function.

6. The solver apparatus according to claim 5, wherein
the penalty coefficient is positive, and
in the coefficient processing, the update unit
subtracts, from each of the J first Lagrange coefficients, a value corresponding to an error between corresponding simultaneous linear equation and the candidate values of the solutions of the I decision variables,
subtracts, from each of the K second Lagrange coefficients, a value corresponding to an error between corresponding alternative equation and the candidate values of the solutions of the I decision variables, and
increases the penalty coefficient.

7. The solver apparatus according to claim 6, wherein
prior to the first processing, the second processing, and the coefficient processing initially performed, the update unit substitutes a predetermined initial value into each of the candidate values of the solutions of the K dependent variables, each of the J first Lagrange coefficients, each of the K second Lagrange coefficients, and the penalty coefficient.

8. The solver apparatus according to claim 1, wherein
in the first processing, the update unit gives a problem that minimizes the first function to a first solver that calculates a solution to a 0-1 integer non-convex quadratic programming problem, and acquires the candidate values of the solutions of the I decision variables from the first solver.

9. The solver apparatus according to claim 8, wherein
when the first solver outputs a plurality of sets of the candidate values of the solutions of the I decision variables, the update unit updates one set of the candidate values of the solutions of the I decision variables based on the plurality of sets of the candidate values of the solutions of the I decision variables.

10. The solver apparatus according to claim 4, wherein
the augmented Lagrange function is expressed by equation (1), and
the K inequalities are expressed by equation (2),
$$L ( x , z , λ , {λ}^{′} , μ ) = {\sum }_{i , {i}^{′}} {x}_{i} \cdot {P}_{i , {i}^{′}} \cdot {x}_{{i}^{′}} + {\sum }_{i} {Q}_{i} \cdot {x}_{i} - {\sum }_{j} {λ}_{j} \cdot ( {\sum }_{i} {A}_{j , i} \cdot {x}_{i} - {B}_{j} ) - {\sum }_{k} {λ}_{k}^{′} \cdot ( {\sum }_{i} {C}_{k , i} \cdot {x}_{i} - {z}_{k} ) + \frac{μ}{2} ( {\sum }_{j} {( {\sum }_{i} {A}_{j , i} \cdot {x}_{i} - {B}_{j} )}^{2} + {\sum }_{k} {( {\sum }_{i} {C}_{k , i} \cdot {x}_{i} - {z}_{k} )}^{2} ) \qquad ( 1 )$$
$${z}_{k} \leq {D}_{k} \qquad ( 2 )$$
where, in the equation (1) and the equation (2),
i is an integer equal to or larger than one and equal to or less than I, and represents an index to be allocated to each of the I decision variables,
i′ is an integer equal to or larger than one and equal to or less than I, and different from i, and represents an index to be allocated to each of the I decision variables,
xᵢ represents an i-th decision variable of the I decision variables,
x_{i′} represents an i′-th decision variable of the I decision variables,
P_{i, i′} represents a coefficient to be multiplied on a multiplication value of the i-th decision variable and the i′-th decision variable in a second order term of the objective function,
Qᵢ represents a coefficient to be multiplied on the i-th decision variable in a first order term of the objective function,
j is an integer equal to or more than one and equal to or less than J, and represents an index to be allocated to each of the J simultaneous linear equations,
A_{j, i} represents a coefficient to be multiplied on the i-th decision variable in a j-th simultaneous linear equation of the J simultaneous linear equations,
Bⱼ represents a constant term in the j-th simultaneous linear equation,
k is an integer equal to or more than one and equal to or less than K, and represents an index to be allocated to each of the K simultaneous linear inequalities,
C_{k, i} represents a coefficient to be multiplied on the i-th decision variable in a k-th simultaneous linear inequality of the K simultaneous linear inequalities,
Dₖ represents a constant term in the k-th simultaneous linear inequality,
zₖ represents a dependent variable in a k-th alternative equation,
λⱼ represents a j-th first Lagrange coefficient of the J first Lagrange coefficients,
λ′ₖ represents a k-th second Lagrange coefficient of the K second Lagrange coefficients, and
μ represents the penalty coefficient.

11. A solver apparatus that calculates a solution to a problem under a condition, the problem minimizing an objective function that is a function obtained by adding a non-convex quadratic function including I (I is an integer equal to or more than two) first decision variables that are each zero or one, and a continuous convex function including M (M is an integer equal to or more than two) second decision variables that are each a real number, and the condition satisfying J (J is an integer equal to or more than zero) simultaneous linear equations that each include at least one of the I first decision variables and the M second decision variables as a variable, and satisfying K (K is an integer equal to or more than one) simultaneous linear inequalities that each include at least one of the I first decision variables and the M second decision variables as a variable, the solver apparatus comprising:
one or more hardware processors configured to function as:
an acquisition unit that acquires the objective function, the J simultaneous linear equations, and the K simultaneous linear inequalities;
an update unit that repeats first processing, second processing, and coefficient processing in predetermined order, the first processing acquiring candidate values of solutions of the I first decision variables that minimize a first function including the I first decision variables generated based on an augmented Lagrange function, the second processing acquiring candidate values of solutions of the M second decision variables and K dependent variables that minimize a second function including the M second decision variables and the K dependent variables generated based on the augmented Lagrange function, and the coefficient processing updating a coefficient included in the augmented Lagrange function; and
an output unit that outputs the candidate values of the solutions of the I first decision variables as the solution to the problem when a preset end condition is reached by repeating the first processing, the second processing, and the coefficient processing, wherein
the augmented Lagrange function includes an objective function term including the objective function, J first Lagrange terms corresponding to the J simultaneous linear equations, K second Lagrange terms corresponding to the K simultaneous linear inequalities, and a penalty term.

12. The solver apparatus according to claim 11, wherein
each of the J first Lagrange terms is a function obtained by multiplying a function expressing an error by a corresponding first Lagrange coefficient of J first Lagrange coefficients, the error being an error between a corresponding simultaneous linear equation of the J simultaneous linear equations, and the candidate values of the solutions of the I first decision variables and the M second decision variables,
each of the K second Lagrange terms is a function obtained by multiplying a function expressing an error by a corresponding second Lagrange coefficient of the K second Lagrange coefficients, the error being an error between an alternative equation and the candidate values of the solutions of the I first decision variables and the M second decision variables, and the alternative equation being obtained by replacing an inequality sign of a corresponding simultaneous linear inequality of the K simultaneous linear inequalities with an equal sign, and replacing a constant term with a corresponding dependent variable of the K dependent variables, and
the penalty term is a function obtained by multiplying a sum of J first distance functions and K second distance functions by a penalty coefficient, the J first distance functions each expressing a distance between a corresponding simultaneous linear equation and the candidate values of the solutions of the I first decision variables and the M second decision variables, and the K second distance functions each expressing a distance between a corresponding alternative equation and the candidate values of the solutions of the I first decision variables and the M second decision variables.

13. The solver apparatus according to claim 12, wherein
in the second processing, the update unit acquires the candidate values of the solutions of the M second decision variables and the K dependent variables of the second function under a condition that satisfies K inequalities, and
each of the K inequalities expresses that a corresponding dependent variable of the K dependent variables is equal to or less than a constant term in a corresponding simultaneous linear inequality of the K simultaneous linear inequalities.

14. The solver apparatus according to claim 13, wherein
the first function is a function obtained by substituting into the augmented Lagrange function the candidate values of the solutions of the K dependent variables and the M second decision variables calculated by the second processing performed immediately before, and
the second function is a function obtained by substituting into the augmented Lagrange function the candidate values of the solutions of the I first decision variables calculated by the first processing performed immediately before.

15. The solver apparatus according to claim 14, wherein
in the second processing, the update unit gives the second function and the K inequalities to a second solver that calculates a solution to a convex quadratic programming problem, and acquires from the second solver the candidate values of the solutions of the M second decision variables and the K dependent variables in the second function.

16. The solver apparatus according to claim 14, wherein
the augmented Lagrange function is expressed by equation (3), and
the K inequalities are expressed by equation (4),
$$L ( x , y , z , λ , {λ}^{′} , μ ) = {\sum }_{i , {i}^{′}} {x}_{i} \cdot {P}_{i , {i}^{′}} \cdot {x}_{{i}^{′}} + {\sum }_{i} {Q}_{i} \cdot {x}_{i} - {\sum }_{j} {λ}_{j} \cdot ( {\sum }_{i} {A}_{j , i} \cdot {x}_{i} + {\sum }_{m} {E}_{j , m} \cdot {y}_{m} - {B}_{j} ) - {\sum }_{k} {λ}_{k}^{′} \cdot ( {\sum }_{i} {C}_{k , i} \cdot {x}_{i} + {\sum }_{m} {E}_{j , m} \cdot {y}_{m} - {B}_{j} ) - {\sum }_{k} {λ}_{k}^{′} \cdot ( {\sum }_{i} {C}_{k , i} \cdot {x}_{i} + {\sum }_{m} {F}_{k , m} \cdot {y}_{m} - {z}_{k} ) + \frac{μ}{2} ( {\sum }_{j} {( {\sum }_{i} {A}_{j , i} \cdot {x}_{i} + {\sum }_{m} {E}_{j , m} \cdot {y}_{m} - {B}_{j} )}^{2} + {\sum }_{k} {( {\sum }_{i} {C}_{k , i} \cdot {x}_{i} + {\sum }_{m} {F}_{k , m} \cdot {y}_{m} - {z}_{k} )}^{2} ) + R ( {y}_{m} ) \qquad ( 3 )$$
$${z}_{k} \leq {D}_{k} \qquad ( 4 )$$
where, in the equation (3) and the equation (4),
i is an integer equal to or larger than one and equal to or less than I, and represents an index to be allocated to each of the I first decision variables,
i′ is an integer equal to or larger than one and equal to or less than I, and different from i, and represents an index to be allocated to each of the I first decision variables,
xᵢ represents an i-th first decision variable of the I first decision variables,
x_{i′} represents an i′-th first decision variable of the I first decision variables,
P_{i,i′} represents a coefficient to be multiplied on a multiplication value of the i-th first decision variable and the i′-th first decision variable in a second order term of the objective function,
Qᵢ represents a coefficient to be multiplied on the i-th first decision variable in a first order term of the objective function,
R(y) represents the continuous convex function,
yₘ represents an m-th second decision variable of the M second decision variables,
j is an integer equal to or more than one and equal to or less than J, and represents an index to be allocated to each of the J simultaneous linear equations,
A_{j, i} represents a coefficient to be multiplied on the i-th first decision variable in a j-th simultaneous linear equation of the J simultaneous linear equations,
E_{j, m} represents a coefficient to be multiplied on the m-th second decision variable in the j-th simultaneous linear equation,
Bⱼ represents a constant term in the j-th simultaneous linear equation,
k is an integer equal to or more than one and equal to or less than K, and represents an index to be allocated to each of the K simultaneous linear inequalities,
C_{k, i} represents a coefficient to be multiplied on the i-th first decision variable in a k-th simultaneous linear inequality of the K simultaneous linear inequalities,
F_{k,i} represents a coefficient to be multiplied on the m-th second decision variable in the k-th simultaneous linear inequality,
Dₖ represents a constant term in the k-th simultaneous linear inequality,
zₖ represents a dependent variable in a k-th alternative equation,
λⱼ represents a j-th first Lagrange coefficient of the J first Lagrange coefficients,
λ′ₖ represents a k-th second Lagrange coefficient of the K second Lagrange coefficients, and
μ represents the penalty coefficient.

17. The solver apparatus according to claim 11, wherein
the continuous convex function is a continuous convex quadratic function.

18. A computer program product having a non-transitory computer readable medium including programmed instructions for causing an information processing apparatus to function as a solver apparatus, wherein
the solver apparatus calculates a solution to a problem under a condition, the problem minimizing an objective function that is a non-convex quadratic function including I (I is an integer equal to or more than two) decision variables that are each zero or one, and the condition satisfying J (J is an integer equal to or more than zero) simultaneous linear equations that each include at least one of the I decision variables as a variable and satisfying K (K is an integer equal to or more than one) simultaneous linear inequalities that each include at least one of the I decision variables as a variable, the program causing the information processing apparatus to function as:
an acquisition unit that acquires the objective function, the J simultaneous linear equations, and the K simultaneous linear inequalities,
an update unit that repeats first processing, second processing, and coefficient processing in predetermined order, the first processing acquiring candidate values of solutions of the I decision variables that minimize a first function including the I decision variables generated based on an augmented Lagrange function, the second processing acquiring candidate values of solutions of the K dependent variables that minimize a second function including K dependent variables generated based on the augmented Lagrange function, and the coefficient processing updating a coefficient included in the augmented Lagrange function, and
an output unit that outputs the candidate values of the solutions of the I decision variables as the solution to the problem when a preset end condition is reached by repeating the first processing, the second processing, and the coefficient processing, wherein
the augmented Lagrange function includes an objective function term including the objective function, J first Lagrange terms corresponding to the J simultaneous linear equations, K second Lagrange terms corresponding to the K simultaneous linear inequalities, and a penalty term.

19. A computer program product having a non-transitory computer readable medium including programmed instructions for causing an information processing apparatus to function as a solver apparatus, wherein
the solver apparatus calculates a solution to a problem under a condition, the problem minimizing an objective function that is a function obtained by adding a non-convex quadratic function including I (I is an integer equal to or more than two) first decision variables that are each zero or one, and a continuous convex function including M (M is an integer equal to or more than two) second decision variables that are each a real number, and the condition satisfying J (J is an integer equal to or more than zero) simultaneous linear equations that each include at least one of the I first decision variables and the M second decision variables as a variable and satisfying K (K is an integer equal to or more than one) simultaneous linear inequalities that each include at least one of the I first decision variables and the M second decision variables as a variable, the program causing the information processing apparatus to function as:
an acquisition unit that acquires the objective function, the J simultaneous linear equations, and the K simultaneous linear inequalities,
an update unit that repeats first processing, second processing, and coefficient processing in predetermined order, the first processing acquiring candidate values of solutions of the I first decision variables that minimize a first function including the I first decision variables generated based on an augmented Lagrange function, the second processing acquiring candidate values of solutions of the M second decision variables and K dependent variables that minimize a second function including the M second decision variables and the K dependent variables generated based on the augmented Lagrange function, and the coefficient processing updating a coefficient included in the augmented Lagrange function, and
an output unit that outputs the candidate values of the solutions of the I first decision variables as the solution to the problem when a preset end condition is reached by repeating the first processing, the second processing, and the coefficient processing, wherein
the augmented Lagrange function includes an objective function term including the objective function, J first Lagrange terms corresponding to the J simultaneous linear equations, K second Lagrange terms corresponding to the K simultaneous linear inequalities, and a penalty term.
